(19) United States
(12) Patent Application Publication
(10) Pub. No.: US 2012/0304246 A1
(43) Pub. Date: Nov. 29, 2012

(54) System and Method for Selective Security of Wireless Bearers

(76) Inventors: Qiang Zhang, Fairfax, VA (US); Frank Wang, Oak Hill, VA (US)

(21) Appl. No.: 13/480,530

(22) Filed: May 25, 2012

Related U.S. Application Data
(60) Provisional application No. 61/489,726, filed on May 25, 2011.

(51) Int. Cl. G06F 21/00

(52) U.S. Cl. 726/1

(57) ABSTRACT

A system is provided for use by a wireless cellular base station and core network to inspect and perform security actions on the input and output data stream based on policy driven security settings per application bearer for each subscriber.

The present application claims priority from U.S. Provisional Application No. 61/489,726 filed May 25, 2011, the entire disclosure of which is incorporated herein by reference.

### BACKGROUND

Long term evolution or LTE, is a standard for wireless communication of high-speed data for mobile phones and data terminals. The goal of LTE is to increase the capacity and speed of wireless data networks using digital signal processing techniques and modulations that have recently been developed.

The world's first LTE service was launched in Stockholm and Oslo in late 2009. LTE is the natural upgrade path for carriers with GSM/UMTS networks, and even CDMA providers are beginning a transition to LTE. For this reason LTE is anticipated to become the first truly global mobile phone standard.

In anticipation of the LTE standard growth, it is necessary to begin developing more efficient applications that are less taxing and expensive. A set of users exist, who require all or portion of their transmitted data to be encrypted. Current wireless communications networks employ an on/off confidentiality and integrity protection support for all users on the network.

FIG. 1 illustrates an example communications network 100.

As illustrated in the figure, wireless communications network 100 includes a cellular base station 102, a cellular base station 104, a cellular base station 106, service center (SC) 108, a SC 110, an IP Transport (IPT) 112, a backhaul (BH) 114, and a BH 116. SC 108 further includes an IP router 118, a security gateway (SecGW) 120, a System Architecture Evolution (SAE) gateway 122, and a SecGW 124. SC 110 further includes SecGW 126, IP router 128, an SAE gateway 130, and a SecGW 132.

Cellular base station 102 is arranged such that is able to transmit data wirelessly from/to cell phones (not shown) to/from SAE gateway 122 through SecGW 124 of SC 108. Secure data is transmitted over SCL 134 and unsecured data is transmitted over UCL 142. Cellular base station 102 is additionally arranged such that it is able to transmit data wirelessly from/to cell phones (not shown) to/from SAE gateway 130 through SecGW 132 of SC 110. Secure data is transmitted over SCL 136 and unsecured data is transmitted over UCL 144. Note the SCL (134, 136) and UCL (142, 144) cannot be applied at same time as the limitation of the prior art of the invention, it is either SCL or UCL and cannot be both as a system wide setting.

Cellular base station 106 is arranged such that is able to transmit data wirelessly from/to cell phones (not shown) to/from SAE gateway 130 through SecGW 132 of SC 110. Secure data is transmitted over SCL 140 and unsecured data is transmitted over UCL 146. Cellular base station 106 is additionally arranged such that it is able to transmit data wirelessly from/to cell phones (not shown) to/from SAE gateway 122 through SecGW 124 of SC 108. Secure data is transmitted over SCL 138 and unsecured data is transmitted over UCL 148. Note the SCL (140, 138) and UCL (146, 148) cannot be applied at same time as the limitation of the prior art of the invention, it is either SCL or UCL and cannot be both as a system wide setting.

Note that the data intercepted by BH 114 or BH 116 is sent back on the same communication line on which it was received. For example, data intercepted on UCL 148 is sent to SAE gateway 122 via UCL 148 and data that is intercepted from SCL 138 is sent to SAE gateway 122 via SCL 138, note the SCL and UCL cannot be applied at same time as a system wide setting.

IPT 112 is arranged to receive data from IP router 118 via hardline 148 and IP router 128 via hardline 150.

A secure communications line is a communications line in between two access points to provide communication security. An unsecure communications line is any line connecting two access points without applying any communication security mechanisms.

In operation, a user may want to transmit or receive data of two different types: sensitive and non-sensitive. If a user wants to transmit or receive non-sensitive data, it can be transmitted or received in an unsecure manner, meaning that an unintended recipient may have access to the data. For example if the non-sensitive data is transmitted in an unencrypted form, an unintended recipient may access the data while being transmitted from the user to the intended recipient. It is possible, at a user's request, to send non-sensitive data in a secure form but is not necessary.

If a user is transmitting or receiving data that is sensitive it must be transmitted or received in a secure manner, meaning that an unintended recipient should not have access to the data. For example if the sensitive data is transmitted in an encrypted form, an unintended recipient may access the encrypted data while being transmitted from the user to the intended recipient. However, in such a case, the unintended recipient may not be able to decrypt the data. As such, the unintended recipient will not have access to the decrypted data. All sensitive data that is transmitted in a secure manner is transmitted over a secure transmission network.

In conventional wireless communication systems there is no way to differentiate between sensitive and non-sensitive data. Data that is being transmitted is already encoded when it reaches the network, so the network has no way of distinguishing between data types. To achieve secure transmission of a user's sensitive data, all of the user's data must be treated as sensitive. In other words, a user may transmit all data in a secure manner over a secure network or the user may transmit all data in an unsecure manner over an unsecure network.

This method of on/off security is very inefficient due to the fact that a user may only be transmitting/receiving one type of data that is sensitive while the other types may be non-sensitive, or a set of users want to transmit/receive sensitive data as well as non-sensitive data while another set of users don't transmit/receive any sensitive data but only non-sensitive data . For example, if a user is transmitting/receiving sensitive voice data, non-sensitive text data, and non-sensitive internet data, the user will transmit/receive all three types of data through a secure network to ensure that the sensitive voice data will remain secure. As such, all three types will be treated as sensitive and transmitted in a secure manner due to the networks lack of ability to differentiate them.

In an example embodiment, a user will want to transmit sensitive data from one console to another. In this example, the console is a phone and the sensitive data being transmitted is voice data. The phone will transmit data to the closest available base station, which in this example, is cellular base station 102. Once the sensitive data is acquired by cellular base station 102, it is transmitted via SCL 134 through BH 114 to SecGW 124.

Cellular base station 102 (or a serving gateway associated with cellular base station 102) has been pre-provisioned to send all bearer traffic through secure communication channel to SC. Once cellular base station 102 receives user traffic, it encrypts the data and sends the data from base station 102 to or from SC 108 over SCL 134. The data is received by SecGW 124 of SC 108 or base station 102, which will decide where the information needs to be sent next.

If a data recipient is in range of SC 108, the information is passed to SAE gateway 122. SAE gateway 122 acts as a wireless router, and will retransmit the data through a SecGW over a SCL to the base station the recipient is attached to. From the base station the data will be further transmitted to the intended user.

SecGW 120 of SC 108 and SecGW 126 of SC 110 arc in place to grant access to each SC and even further IPT 122. Each SecGW is in place to either grant or deny users access to the network that arc customers of sister or parent service providers.

A problem with the current method of transmitting/receiving data securely in a wireless communication system is that there is no way to differentiate sensitive data from non-sensitive data. Suppose a user is only transmitting sensitive voice data while all other transmitted data is non-sensitive. In current communications networks there is no way to differentiate between the two, and both types arc transmitted as if they were sensitive. This is a very inefficient method of transmitting sensitive data.

Another problem with current communications networks is that to transmit sensitive data, security hardware and software must be installed at each Service Center SC to support the secure transmission of data. The installation and maintenance of this hardware and software is very expensive and time intensive.

What is needed is a method for differentiating sensitive data from non-sensitive data and apply security accordingly within the wireless communication system.

### BRIEF SUMMARY

The present invention provides a system and method for differentiating data that needs to be transmitted and received securely from all other data that a user may be transmitting or receiving. In accordance with an aspect of the present invention, a system is provided for use by a user and with a server and a content output device, the server being operable to provide a stream of input content. The content output device can output content based on the stream of input content. The stream of input content includes a chunk of content data. The system includes a receiver, an interactive playback controller portion, a playback indicator, a storage portion and an output portion. The receiver can receive the stream of input content as downloaded data. The playback indicator can indicate a location of the chunk within the stream of input content. The storage portion can store the downloaded data. The output portion can output an output signal, based on the downloaded data, to the content output device. The interactive playback controller portion can enable the user to instruct the output portion to output the chunk of content data as the output signal.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a prior art wireless communications network 100;

FIG. 2 illustrates a wireless communications network, in accordance with aspects of the present invention;

FIG. 3 illustrates the function of a base station and serving gateway, in accordance with aspects of the present invention;

FIG. 4 illustrates a database of policy information, in accordance with aspects of the present invention;

FIG. 5 illustrates the creation a secure transmission channel, in accordance with aspects of the present invention; and

FIG. 6 illustrates the execution of security action for bearers, in accordance with aspects of the present invention.

### DETAILED DESCRIPTION

Aspects of the present invention provide a system and method for determining the type of data being transmitted/received from/by a specific user and distinguishing whether the data is sensitive or non-sensitive. If it is determined that the data being transmitted is, non-sensitive, it is transmitted in an unsecure manner. If it is determined that the data being transmitted is sensitive, it is transmitted in a secure manner.

To improve the system efficiency and balance system architecture, a method is provided to apply security processing at per bearer security setting. This is achieved by combining the wireless core signaling with the differentiated user plane execution of the security policy.

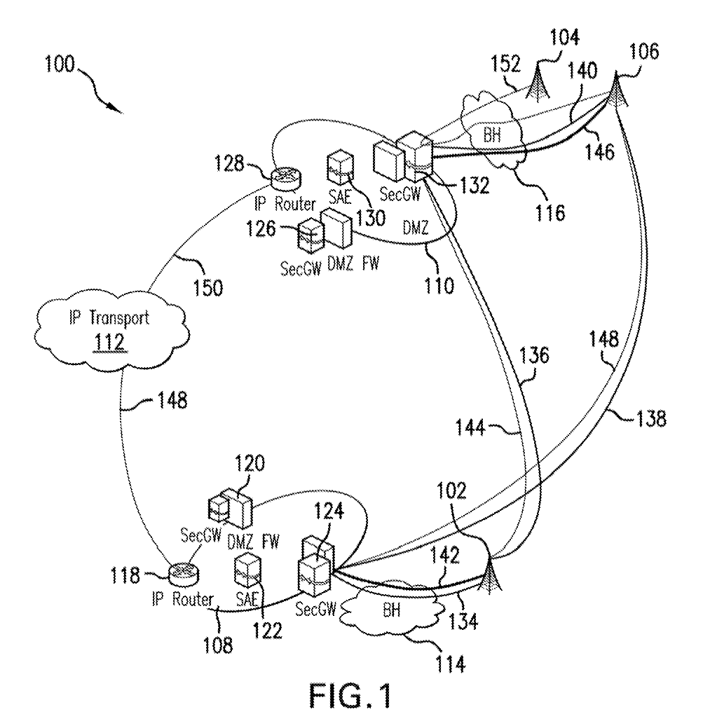

In contrast with the conventional wireless system discussed above with reference to FIG. 1, in accordance with aspects of the present invention, the system does not need to contain on/off confidentiality and integrity protection support for all users.

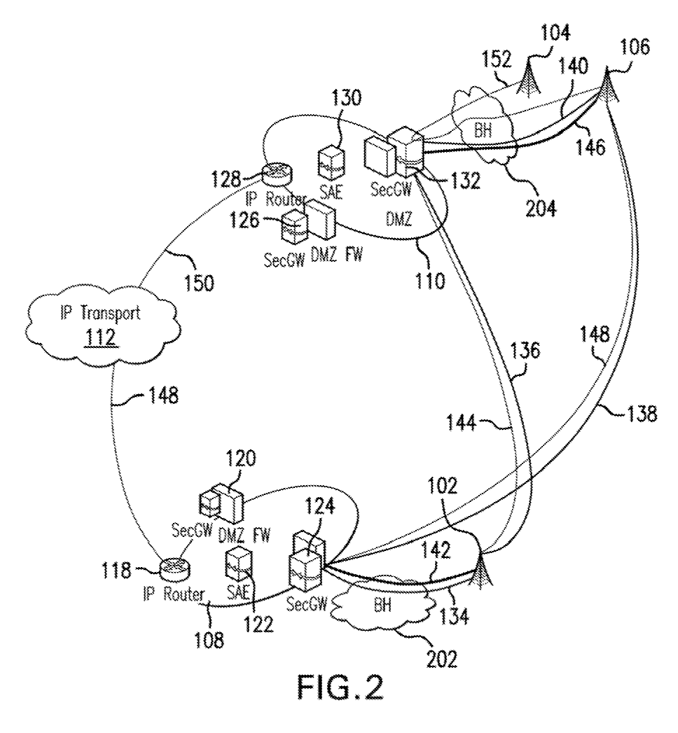

The aspect of the present invention will now be described in greater detail with reference to FIG. 2.

FIG. 2 illustrates an example communications network 200 that sends user data to secured service centers in accordance with aspects of the present invention.

As illustrated in FIG. 2, communications network 200 includes all of the elements, of FIG. 1, except BH 114 has been replaced with BH 202 and BH 116 has been replaced with BH 204. For purposes of brevity, elements (and their respective functions) that are common between communications network 100 and communications network 200 may not be described again.

In operation, a user may want to transmit/receive data of two different types: sensitive and non-sensitive. If a user wants to transmit/receive non-sensitive data it can be transmitted/received in an unsecure manner, whereas if a user is transmitting/receiving data that is sensitive it may be transmitted in a secure manner. In communications network 200, in accordance with aspects of the present invention, there is a system and method for differentiating sensitive data from non-sensitive data. A user may transmit/receive data of any type, wherein the type of data is cross-referenced with a database to determine if the type of data is sensitive for the user. If the data being transmitted/received is found to be sensitive, it is transmitted over a secure communication link. If the data being transmitted/received is found to be non-sensitive, it is transmitted/received over an unsecure communication link.

In an example embodiment, consider the situation where a user transmits data from his user terminal to another user terminal. In this example, let the user terminal of the user be a phone. The phone will transmit data to the base station currently attached to. For purposes of discussion, in this example, let the cellular base station be cellular base station 102. Once the data is acquired by base station 102, it is transmitted via SCL 134 through BH 202.

Cellular base station 102 contains a rule portion that receives the identification of the user that is transmitting data. The rule portion contains a data base of users, the types of data they use, and a security policy for each particular type of data that a user may transmit. Cellular base station 102 cross references the identification and data type that a user is transmitting against the database to find the security policy that is associated with it.

If cellular base station 102 cross references the user identification and data type against the data base and finds that the data being transmitted is not sensitive; it will transmit the data over an unsecure communications line. If cellular base station 102 cross references the user identification and data type against the data base and finds that the data being transmitted is sensitive; it will transmit the data over a secure communications line.

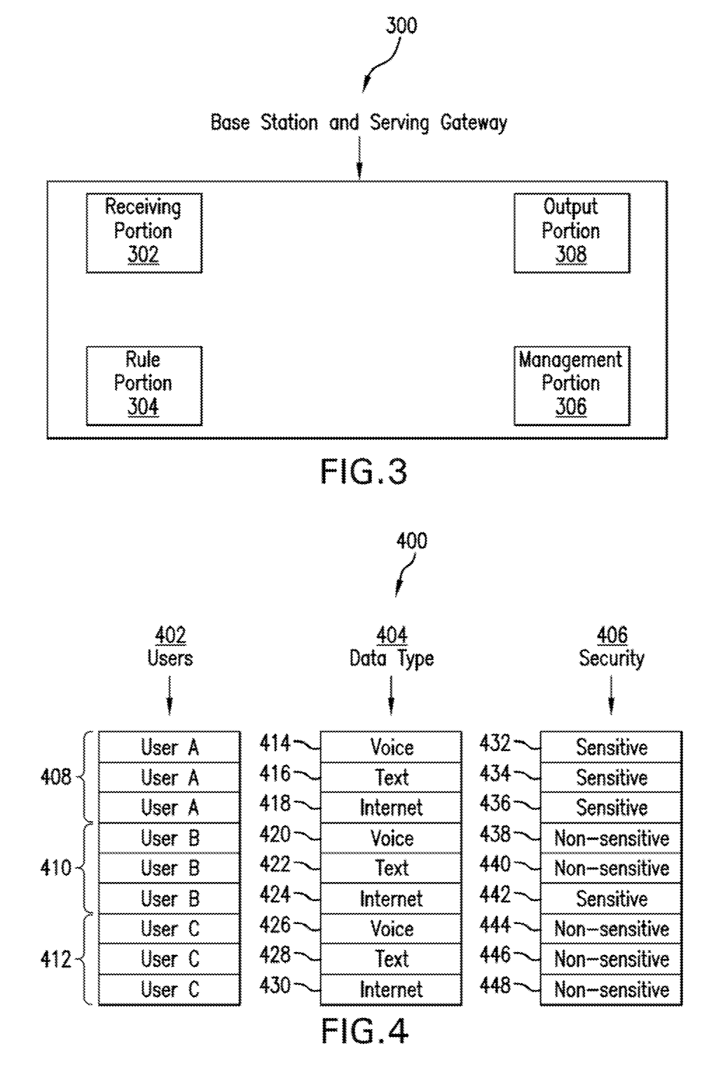

The operation and execution of cellular base station 102 referencing a user's identification and data type against a database is described in greater detail with reference to FIGS. 3-4.

At this point, cellular base station 102 will cross reference the type of data that is being transmitted in addition to the users' identification against a data base. If it finds that the data is non-sensitive it is transmitted over an unsecure communications line to the intended recipient as described in FIG. 1. In this example, cellular base station 102 finds that the data being transmitted is sensitive.

Since cellular base station 102 found that the data being transmitted is sensitive and it needs to be sent in a secure manner. The data must be sent to a SC that has security gateway.

In this example, the sensitive data being transmitted is sent to cellular base station 102 service center which is SC 108. SC 108 contains SecGW 124 which receives the sensitive data from SCL 134.

Once, cellular base station 102 has securely transmitted data to SC 108, the data is received by SecGW 134. Now the secure transmission of data follows the same procedure as described in the prior art example of communications network 100.

If the intended recipient is within range of SC 108, the data is sent over an SCL to the cellular base station the recipient is attached to. The cellular base station will then send the information to the recipient.

If the recipient is not within range of SC 108 it will send the data to IPT 122 where the data will be routed to another SC. From the SC the data will be securely transmitted to the cellular base station the recipient is attached to, and from there it will be sent to the recipient.

The operation of a base station and serving gateway and determining the security setting for different types of data will be further discussed with reference to FIG. 3.

FIG. 3 illustrates the function of base station and serving gateway.

As illustrated in the figure, base station or serving gateway contains a receiver portion 302, a rule portion 304, a management portion 306, and a output portion 308.

Receiver portion 302 is arranged to receive data that has been transmitted to/from a user. Rule portion 304 is arranged to cross reference transmitted data against policy information that is stored within. Management portion 306 is arranged to output a connection to output 308 based on policy information. Output portion 308 is arranged to output a user transmission to a secured communication line or unsecured communication line based on connection instruction.

In operation, a user will transmit/receive data that is either sensitive or non-sensitive to/from an endpoint. Data that is transmitted is received by a cellular base station or serving gateway, which then sends the data to backhaul 302. The transmitted data is received by receiving portion 302 on the cellular base station or serving gateway depending on the transmitting direction.

Once the data is received by receiving portion 302 it sends information about the type of data being transmitted and user's identification to rule portion 304. Rule portion 304 contains a database of users, data types, and policy information. Rule portion 304 checks the data base to find out what kind of security is associated with the data type being transmitted for that particular user.

After rule portion 304 finds the type of security that is required for the data being transmitted it sends security information to management portion 306. Based on the policy information sent from rule portion 304, management portion 306 will send out connection instructions to output portion 308.

Output portion 308 will transmit a user's data to a SCL or an unsecured communication line. If the type of data being transmitted is found to be sensitive, management portion 306 will instruct output portion 308 to transmit data to a SCL. If the type of data being transmitted is found to be non-sensitive, management portion 306 will instruct output portion 308 to transmit the data to an unsecured communication line.

The database of policy information will be further discussed with reference to FIG. 4.

FIG. 4 illustrates a database of policy information.

As illustrated in the figure, database 400 includes a user column 402, a data type. column 404, and a security column 406. User column 402 further includes a User 408, a User 410, and a User 412. Data type column 404 further includes types of data that are transmitted by each individual user. Security column 406 further includes a sensitive or non-sensitive policy for each individual type of data for each individual user.

In operation, a rule portion will need to check policy information for a user that is transmitting data of some type to determine the security required. In this example, User 408 is transmitting voice data. If User 408 is transmitting voice data, the rule portion will first locate User 408 with in user column 402.

Once the rule portion has located User 408, it will locate the type of data being transmitted in data type column 404, which in this example is voice data. Once the rule portion has located voice data in box 414 for User 408 it checks security column 406 to determine the security setting that is needed.

The rule portion determines from inspecting box 432 that User 408 is transmitting sensitive voice data, it will send security information to a management portion. Once the management portion is informed that the type of data being transmitted is sensitive it will instruct the output portion to transmit the data to a security gateway.

In another example embodiment, suppose User 412 is transmitting internet data. The rule portion will find User 412 in user column 402. Once User 412 is located, the rule portion will locate the type of data being transmitted in data type column 404. After locating internet data in box 430 of data type column 404 it will check adjacent security column 406 for security information.

Once the rule portion has determined, from box 448 of security column 406, that User 512 is transmitting non-sensitive internet data, it sends security information to the management portion. The management portion will instruct the output portion that the type of data being transmitted is non-sensitive and that it should be sent to an unsecure gateway.

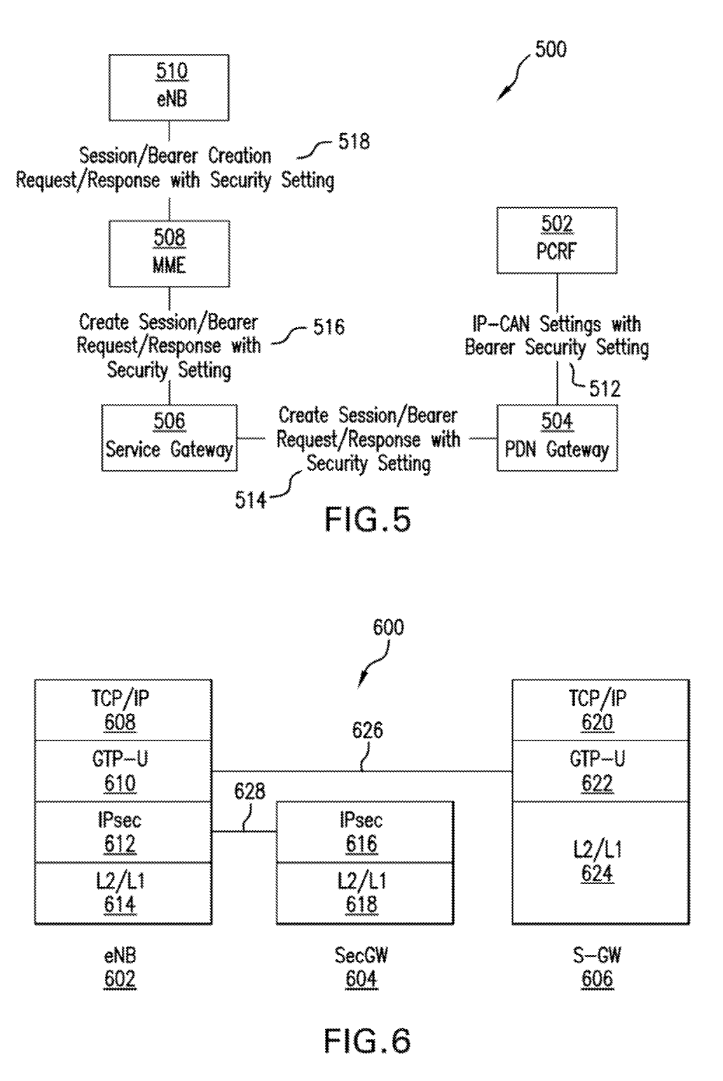

The second aspect of the present invention will now be described in greater detail with reference to FIGS. 5-6.

FIG. 5 illustrates a process 500 of creating a secure transmission channel, in accordance with aspects of the present invention.

As illustrated in the figure, process 500 includes a policy charging role function portion (PCRF) 502, a packet data network gateway portion (PDN gateway) 504, a serving gateway 506, a mobility management entity portion (MME) 508, and an evolved node B (eNB) 510.

PCRF 502 is arranged such that it is able to send IP-Can settings and bearer security settings 512 to PDN gateway 504. PDN gateway 504 is arranged to send bearer request and security setting response 514 to serving gateway 506. Serving gateway 506 is arranged to send bearer and security setting response 516 to MME 508. MME 508 is arranged to send bearer and security setting response 518 to cNB 510.

PCRF 502 is a policy charging role function portion that is able to access subscriber policies that are contained within a database.

PDN gateway 504 is a gateway that that is operable to communicate with PCRF 502 and send and receive messages from serving gateway 506.

Serving gateway 506 is operable to send and receive messages from both PDN gateway 504 and MME 508. Serving gateway 506 is additionally operable to associate a bearer with its respective security settings.

MME 508 is operable to send and receive messages from serving gateway 506. MME 508 is additionally operable to create a control session with eNB 510.

eNB 510 is operable to inspect bearer security settings that are sent from MME 508, and if needed, able to execute security action for a bearer.

In operation, there may be several different situations in which a secure bearer creation is needed. The bearer creation may be initiated by the network or by a user.

There are two separate ways of creating a bearer security setting. One method involves defining a new bearer security policy attribute that can be stored in a database which is accessible by PCRF 502. When a bearer creation request is made, PCRF 502 can check the database and send the security settings in the body of the create bearer request/response.

A second method of creating the bearer security setting is to use the quality of service (QoS) attribute. This method involves adding extra characters in the QoS attribute that will act as flag indicators. These flag indicators arc contained in the body of the create bearer request/response and will indicate whether or not the bearer being created needs to be secured.

In an example embodiment, the bearer creation may be initiated by the network. In this example, there is a create bearer request 514 that originates from PDN gateway 504. The bearer security settings are contained in a database accessible by PCRF 502.

Create bearer request 514 is sent from PDN gateway 504 to serving gateway 506. Serving gateway 506 will inspect the create bearer request to determine its security settings. If the security settings are off, normal standard procedure is performed. If serving gateway 506 finds that the security settings are on, an association of the bearer with the security settings is performed.

Association of the bearer with the security setting, is done by creating S1-TEID and assigning it a secure attribute at base station and serving gateway. Creating a secure tunnel is achieved by two possible approaches A: running GTP on a UDP port in additional to well-known port 2512, transmitting data to a security gateway that contain different security policy for the UDP ports (secured and non-secured). B: base station and serving gateway to perform policy based routing, secured tunnel will be routed to a security gateway for security action, non-secured tunnel will be routed to an IP router that won't perform security action.

After an association of the bearer with the security settings is performed serving gateway 506 will send create bearer request 516 to MME 508.

At this point, MME 508 creates session management request 518 using the configurations of create bearer request 516, that had been relayed from serving gateway 506. Session management request 518 is sent to cNB 510, and contains the same bearer security settings as create bearer request 516.

eNB 502 will inspect the bearer security settings, and if required for the S1-TEID, will execute security action for the bearer.

The execution of security action for bearers will now be described in further detail with reference to FIG. 6.

FIG. 6 illustrates the execution of security action for bearers, in accordance with aspects of the present invention.

As illustrated in the figure, system 600 includes an eNB 602, a serving gateway 604, and a SecGW 606. eNB 602 further includes a TCP/IP portion 608, a GTP-U portion 610, a IPsec portion 612, and a L2/L1 portion 614. S-GW 604 further includes a TCP/IP portion 620, a GTP-U portion 622, and a L2/L1 portion 624. SccGW 606 further includes IPsec portion 616 and L2/L1 portion 618.

cNB 602 is arranged to establish a secure IP address with SecGW 606. eNB 602 is additionally arranged to establish a transport layer for data streams with S-GW 604.

L2/L1 portion 614, L2/L1 portion 618, and L2/L1 portion 624 are protocols for the physical layer and provide a generic framing procedure.

IPsec portion 612 and IPsec portion 616 are protocol suites for securing IP communications by authenticating and encrypting each IP packet of a communication session. IPsec portion 612 and IP see portion 616 arc part of the network layer.

GTP-U portion 610 and GTP-U portion 622 are IP based protocols for the transport layer for data streams.

TCP/IP portion 608 and TCP/IP portion 620 are protocol suites that define the abstraction layers and their associated protocols. TCP/IP portion 608 and TCP/IP portion 620 are part of the application layer.

In operation, eNB 602 will first receive user's data that needs to be encrypted which is the TCP/IP layer data. The data is passed down to the transport layer.

Once the data enters the transport layer it is subjected to GTP-U portion 610. GTP-U portion 610 gives the encapsulated information a GTP header which contains the TEID. The TEID indicates which tunnel the information will be travelling through.

In this example, the GTP-TEID assigned to the data is given by GTP-U portion 622 of serving gateway 604. The transport bearer is identified by not only the GTP-U but also by the IP address which is obtained in the network layer.

Once the data has been assigned a GTP-TEID in the transport layer it is passed down to the network layer. In the network layer, two approaches can be taken A:IPsec portion 612 of eNB 602 communicates with IPsec portion 616 of SecGW 606 to obtain a security association. IPsec portion 612 and IPsec portion 616 are configured to protect the traffic using the GTP port that is defined as secure for any GTP-U tunnel, while does not protect the traffic using the GTP port that is defined as non-secure for any GTP-U tunnel. B: a routing engine looks up the security setting associated with the GTP-TEID, if it is a traffic with security setting set to on, route the data to IPsec portion 612, if it is traffic with security setting set to off, route the data to bypass IPsec portion to different route.

After the data has been encapsulated or bypassed in the IPsec portions of the network layer, it is passed down into the physical layer. In the physical layer L2/L1 portion 614 defines framing for the data. After a successful framing, the data is transmitted to its endpoint where the encapsulation and manipulation of data is reversed as it ascends each layer.

A benefit of the present invention can be seen with respects to systems 500 and 600. The process of applying security processing per user, per application, or per bearer security level provides system architecture balance as well as better system efficiency.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A device for use in communication system operating within an Internet protocol communications suite and including a user device, an unsecure gateway, a security gateway and a secure network, the user device being operable to transmit a user transmission, the unsecure gateway being operable to receive the user transmission and provide the user transmission to the Internet via an unsecure communication channel, the security gateway being operable to receive the user transmission, to encrypt the user transmission and to provide the encrypted user transmission to the secure network via a secure communication channel, said device comprising:
a receiver portion operable to receive the user transmission;
a rule portion having policy information stored therein, the policy information including communication type information and security level information;
a management portion operable to output a connection instruction based on the policy information; and
an output portion operable to output the user transmission to one of the unsecure gateway and the security gateway based on the connection instruction.

2. The device of claim 1,
wherein said rule portion includes a memory portion having a user data structure, a data type data structure and a security level data structure,
wherein the user data structure includes user identification data identifying the user,
wherein the data type data structure includes data type identification data distinguishing between a first type of data and a second type of data, and
wherein the security level data structure includes security level identification data distinguishing between unsecure data and secure data.

3. The device of claim 2,
wherein the first type of data comprises voice data, and
wherein the second type of data comprises non-voice data.

4. The device of claim 2,
wherein the data type data structure includes data type identification data distinguishing between a first type of data provided by the user and a second type of data provided by the user, and
wherein the security level identification data indicates that the first type of data provided by the user comprises unsecure data and the second type of data provided by the user comprises secure data.

5. The device of claim 4,
wherein said management portion is further operable to output the connection instruction as an unsecure connection instruction when the user transmission is the first type of data,
wherein said management portion is further operable to output the connection instruction as a secure connection instruction when the user transmission is the second type of data,
wherein said output portion is further operable to output the user transmission to the unsecurity gateway based on the unsecure connection instruction, and
wherein said output portion is further operable to output the user transmission to the security gateway based on the secure connection instruction.

6. A method of communicating in a communication system operating within an Internet protocol communications suite and including a user device, an unsecure gateway, a security gateway and a secure network, the user device being operable to transmit a user transmission, the unsecure gateway being operable to receive the user transmission and provide the user transmission to the Internet via an unsecure communication channel, the security gateway being operable to receive the user transmission, to encrypt the user transmission and to provide the encrypted user transmission to the secure network via a secure communication channel, said method comprising:
receiving, via a receiver portion, the user transmission;
storing, via a rule portion, information including communication type information and security level information;
outputting, via a management portion, a connection instruction based on the policy information; and
outputting, via an output portion, the user transmission to one of the unsecure gateway and the security gateway based on the connection instruction.

7. The method of claim 6,
wherein said storing, via a rule portion, information including communication type information and security level information comprises storing, via a memory portion, a user data structure, a data type data structure and a security level data structure,
wherein the user data structure includes user identification data identifying the user,
wherein the data type data structure includes data type identification data distinguishing between a first type of data and a second type of data, and
wherein the security level data structure includes security level identification data distinguishing between unsecure data and secure data.

8. The method of claim 7,
wherein first type of data comprises voice data, and
wherein the second type of data comprises non-voice data.

9. The method of claim 7,
wherein the data type data structure includes data type identification data distinguishing between a first type of data provided by the user and a second type of data provided by the user, and
wherein the security level identification data indicates that the first type of data provided by the user comprises unsecure data and the second type of data provided by the user comprises secure data.

10. The method of claim 9,
wherein said outputting, via a management portion, a connection instruction based on the policy information comprises outputting, via the management portion, the connection instruction as an unsecure connection instruction when the user transmission is the first type of data,
wherein said outputting, via a management portion, a connection instruction based on the policy information comprises outputting, via the management portion, the connection instruction as a secure connection instruction when the user transmission is the second type of data,
wherein said outputting, via an output portion, the user transmission to one of the unsecure gateway and the security gateway based on the connection instruction comprises outputting, via the output portion, the user transmission to the unsecure gateway based on the unsecure connection instruction, and
wherein said outputting, via an output portion, the user transmission to one of the unsecure gateway and the security gateway based on the connection instruction comprises outputting, via the output portion, the user transmission to the security gateway based on the secure connection instruction.

11. A non-transitory, tangible, computer-readable media having computer-readable instructions stored thereon, the computer-readable instructions being capable of being read by a computer to be used for communicating in a communication system operating within an Internet protocol communications suite and including a user device, an unsecure gateway, a security gateway and a secure network, the user device being operable to transmit a user transmission, the unsecure gateway being operable to receive the user transmission and provide the user transmission to the Internet via an unsecure communication channel, the security gateway being operable to receive the user transmission, to encrypt the user transmission and to provide the encrypted user transmission to the secure network via a secure communication channel, the tangible computer-readable instructions being capable of instructing the computer to perform the method comprising:
receiving, via a receiver portion, the user transmission;
storing, via a rule portion, information including communication type information and security level information;
outputting, via a management portion, a connection instruction based on the policy information; and
outputting, via an output portion, the user transmission to one of the unsecure gateway and the security gateway based on the connection instruction.

12. The non-transitory, tangible, computer-readable media of claim 11, the computer-readable instructions being capable of instructing the computer to perform said method,
wherein said storing, via a rule portion, information including communication type information and security level information comprises storing, via a memory portion, a user data structure, a data type data structure and a security level data structure,
wherein the user data structure includes user identification data identifying the user,
wherein the data type data structure includes data type identification data distinguishing between a first type of data and a second type of data, and
wherein the security level data structure includes security level identification data distinguishing between unsecure data and secure data.

13. The non-transitory, tangible, computer-readable media of claim 12, the computer-readable instructions being capable of instructing the computer to perform said method,
wherein first type of data comprises voice data, and
wherein the second type of data comprises non-voice data.

14. The non-transitory, tangible, computer-readable media of claim 12, the computer-readable instructions being capable of instructing the computer to perform said method,
wherein the data type data structure includes data type identification data distinguishing between a first type of data provided by the user and a second type of data provided by the user, and
wherein the security level identification data indicates that the first type of data provided by the user comprises unsecure data and the second type of data provided by the user comprises secure data.

15. The non-transitory, tangible, computer-readable media of claim 14, the computer-readable instructions being capable of instructing the computer to perform said method,
wherein said outputting, via a management portion, a connection instruction based on the policy information comprises outputting, via the management portion, the connection instruction as an unsecure connection instruction when the user transmission is the first type of data,
wherein said outputting, via a management portion, a connection instruction based on the policy information comprises outputting, via the management portion, the connection instruction as a secure connection instruction when the user transmission is the second type of data,
wherein said outputting, via an output portion, the user transmission to one of the unsecure gateway and the security gateway based on the connection instruction comprises outputting, via the output portion, the user transmission to the unsecure gateway based on the unsecure connection instruction, and
wherein said outputting, via an output portion, the user transmission to one of the unsecure gateway and the security gateway based on the connection instruction comprises outputting, via the output portion, the user transmission to the security gateway based on the secure connection instruction.
